(19) United States
(12) Patent Application Publication
(10) Pub. No.: US 2017/0284633 A1
(43) Pub. Date: Oct. 5, 2017

(54) GLASS MATERIAL, FLUORESCENT COMPOSITE MATERIAL, AND LIGHT-EMITTING DEVICE

(71) Applicant: CHINA GLAZE CO., LTD., Hsinchu (TW)

(72) Inventors: Yi-Cheng CHIU, Hsinchu (TW); Chih-Sheng LIN, Hsinchu (TW); Sung-Yu TSAI, Hsinchu (TW); Su-Jen WANG, Hsinchu (TW); Chia-Hung TSENG, Hsinchu (TW)

(21) Appl. No.: 15/185,644

(22) Filed: Jun. 17, 2016

(30) Foreign Application Priority Data
Mar. 29, 2016 (TW) 105109809

(51) Int. Cl. F21V 9/16; C09K 11/77; C03C 4/12; C09K 11/02; C03C 3/066; C03C 3/062

(52) U.S. Cl. CPC F21V 9/16; C03C 3/066; C03C 3/062; C03C 4/12; C09K 11/025; C09K 11/7774; C09K 11/7734; C03C 2204/00

(57) ABSTRACT

A glass material is provided, which has a composition of M₂O—ZnO-M′₂0₃—Bi₂O₃—SiO₂, wherein M is Li, Na, K, or a combination thereof, and M′ is B, Al, or a combination thereof. A fluorescent composite material can be composed of the glass material and a phosphor material. The fluorescent composite material may collocate with an excitation light source to provide a light-emitting device.

### CROSS REFERENCE TO RELATED APPLICATIONS

The present application is based on, and claims priority from, Taiwan Application Serial Number 105109809, filed on Mar. 29, 2016, the disclosure of which is hereby incorporated by reference herein in its entirety.

### TECHNICAL FIELD

The technical field relates to a fluorescent composite material of a glass material and a phosphor material, and in particular it relates to the composition of the glass material.

### BACKGROUND

The light-emitting diode (LED) is considered a revolutionary light source with the potential to replace incandescent lamps and fluorescent lamps due to its properties of being energy-saving, and thus less harmful to the environment, as well as the continuous enhancements being made to LED light-emitting efficiency. There are various approaches for generating white light with LEDs: (a) combining with trichromatic RGB LED chips; (b) blue-light LED chip comprised of one or more visible light-emitting phosphors. Phosphor-converted LEDs (pc-LED) are the most common LED based white light source. The phosphor material relates to light-emitting efficiency, stability, color rendering, color temperature, and lifetime, thereby being the most critical material in the white light LED.

In a conventional LED package, phosphor powder and an organic matrix material (e.g. silicone) are mixed and then applied on the LED. However, the above skill has at least two shortcomings: (1) the refractive index mismatch of the silicone and the phosphor powder: silicone generally has a refractive index of about 1.5, and the common YAG phosphor has a refractive index of 1.85, such that the refractive index therebetween will negatively influence the light-extraction efficiency of the package; and (2) silicone is an organic substance, and its environmental stability needs to be enhanced in high-power applications.

Accordingly, a novel matrix material for the phosphor powder is called for to overcome the problems caused by conventional organic silicone.

### SUMMARY

One embodiment of the disclosure provides a glass material, having a composition of: M₂O—ZnO-M′₂O₃—Bi₂O₃—SiO₂, wherein M is Li, Na, K, or a combination thereof; and M′ is B, Al, or a combination thereof, wherein the glass material has 0.5 wt % to 20 wt % of M₂O; 1 wt % to 20 wt % of ZnO; 3 wt % to 60 wt % of M′₂O₃; 25 wt % to 90 wt % of Bi₂O₃; and 1 wt % to 30 wt % of SiO₂.

One embodiment of the disclosure provides a fluorescent composite material, comprising: a phosphor material; and the described glass material.

One embodiment of the disclosure provides a light-emitting device, comprising: an excitation light source; and the described fluorescent composite material on the excitation light source.

A detailed description is given in the following embodiments with reference to the accompanying drawings.

### BRIEF DESCRIPTION OF THE DRAWINGS

The disclosure can be more fully understood by reading the subsequent detailed description and examples with references made to the accompanying drawings, wherein:

FIGS. 1, 3, 5, 6, and 8 show emission spectra of fluorescent composite material in embodiments of the disclosure.

FIGS. 2, 4, 7, and 9-13 show electroluminescent spectra of package structures of a blue LED and fluorescent composite materials in embodiments of the disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

In the disclosure, the phosphor material is collocated with a glass material to manufacture a phosphor composite material to overcome the problems caused by the organic silicone. The glass material formulation is tuned to achieve a high refractive index (>2), thereby increasing the light extraction efficiency. In addition, the glass material is an inorganic material with a higher chemical stability than that of organic packaging resin. However, the red phosphor material easily reacts with a common glass material, such that the light-emitting properties of the composite after sintering are decayed. In other words, the common glass material and the red phosphor material have an insufficient compatibility. For overcoming the problem of the insufficient compatibility between the glass material and the phosphor material, one embodiment of the disclosure provides a glass material having a composition of: M₂O—ZnO-M′₂O₃—Bi₂O₃—SiO₂, wherein M is Li, Na, K, or a combination thereof; and M′ is B, Al, or a combination thereof. When the total weight of the glass material is set as reference (100 wt %), the glass material has 0.5 wt % to 20 wt % of M₂O, 1 wt % to 20 wt % of ZnO, 3 wt % to 60 wt % of M′₂O₃, 25 wt % to 90 wt % of Bi₂O₃, and 1 wt % to 30 wt % of SiO₂. In another embodiment, the glass material has 5 wt % to 10 wt % of M₂O, 5 wt % to 20 wt % of ZnO, 3 wt % to 24.5 wt % of M′₂O₃, 60 wt % of Bi₂O₃, and 7 wt % to 10 wt % of SiO₂. When the Bi₂O₃ weight is set as reference (100 parts by weight), Bi₂O₃ and M₂O have a weight ratio of 100:0.8 to 100:80, Bi₂O₃ and ZnO have a weight ratio of 100:1 to 100:80, Bi₂O₃ and M′₂O₃ have a weight ratio of 100:3 to 100:200, and Bi₂O₃ and SiO₂ have a weight ratio of 100:1 to 100:50. In another embodiment, Bi₂O₃ and M₂O have a weight ratio of 100:0.8 to 100:16.7, Bi₂O₃ and ZnO have a weight ratio of 100:8 to 100:34, Bi₂O₃ and M′₂O₃ have a weight ratio of 100:5 to 100:40.8, and Bi₂O₃ and SiO₂ have a weight ratio of 100:11 to 100:16.6.

Bi₂O₃ may greatly decrease the softening point temperature and increase the refractive index of the glass material. Too little amount of Bi₂O₃ makes the softening point temperature of the glass material beyond the acceptable range of the phosphor material. Therefore, the efficiency was found to decline dramatically after sintering. On the other hand, when its content become more, a glass material cannot be formed because of low viscosity and the chemical durability tends to deteriorate.

M₂O has an effect to lower the melting point of the glass material. Too little amount of M₂O cannot efficiently lower the melting point of the glass material, such that an overly high sintering temperature may cause the light-emitting properties of the fluorescent composite material to decay. Too much amount of M₂O will lower the chemical resistance of the glass material. When M₂O is K₂O, the larger atomic radius of K atom may strengthen the bonding. Simultaneously, the coefficient of expansion of K₂O is less than Na₂O, such that the flexibility and thermal stability of the glass material are enhanced by K₂O.

ZnO may assist in melting, lowering the coefficient of expansion, increasing the gloss, and widening the glass sintering temperature range. Too little amount of ZnO does not assist in melting. Too much amount of ZnO causes it to easily crystallize with SiO₂, thereby negatively influencing the glass transparency and glass structural strength.

B₂O₃ is a component to lower the melting point of the glass material. However, too much amount of B₂O₃ may cause the chemical durability of the glass material tends to deteriorate. Al₂O₃ may increase the abrasion resistance of the glass material and viscosity at the melting point. Nevertheless, too little amount of M′₂O₃ results in an insufficient glass strength. Too much amount of M′₂O₃ may enhance the glass softening point.

In general, SiO₂ is the component for forming the glass network. Too much amount of SiO₂ may increase the melting point and the softening point of the glass material. Consequently, the efficiency of fluorescent composite material was found to decline dramatically after sintering. The glass material cannot be formed by too little amount of SiO₂, thereby degrading the chemical durability of the material.

In one embodiment, M₂O, ZnO, M′₂O₃, Bi₂O₃, and SiO₂ are weighed according to the above ratios, and then heated to be melted. The melted mixture is water-quenched to form a glass bulk. The glass bulk is initially cracked and then ball-milled to obtain glass powder with D₅₀ of about 10 μm to 20 μm. The glass powder and a phosphor powder are mixed evenly, filled into a mold, and then molded by oil hydraulic compression to form a preform. The preform is then sintered at 400° C. to 650° C. to form a fluorescent composite material. It should be understood that the glass powder and the phosphor powder are mixed with each other rather than separated into different layers.

In one embodiment, the phosphor powder has a D₅₀ of about 10 μm to 20 μm. The phosphor material can be red phosphor material, green phosphor material, yellow phosphor material, or a combination thereof. The red phosphor material can be silicate such as (Ba_{1-x-y}SrₓCa_{y})₂SiO₄:Eu²⁺, nitride such as (Ca,Sr)AlSiN₃:Eu²⁺ or (Ca,Sr)₂Si₅N₈:EU²⁺, oxynitride such as α-SiAlON:Eu²⁺, or sulfide such as (Ca,Sr)S:Eu²⁺. The green phosphor material can be aluminate such as (Y,Lu,Gd)₃(Al,Ga)₅O₁₂:Ce³⁺, oxynitride such as (Ba_{1-x-y}SrₓCa_{y})Si₂O₂N₂:EU²⁺ or β-SiAlON:Eu²⁺, or sulfide such as Sr(Al,Ga)₂S₄:Eu²⁺. The yellow phosphor material can be aluminate such as Y₃Al₅O₁₂:Ce³⁺. In one embodiment, the glass material and the phosphor material in the fluorescent composite material have a weight ratio of 1:999 to 90:10. An overly low ratio of the glass material may result in an insufficient strength of the fluorescent composite material. Conversely, higher ratio of the glass material may cause an insufficient light-emitting efficiency of the fluorescent composite material.

The fluorescent composite material may collocate with an excitation light source to generate a light-emitting device. For example, the excitation light source can be light-emitting diode, laser diode, organic light-emitting diode, cold cathode fluorescent lamp, or external-electrode fluorescent lamp. In one embodiment, the light-emitting device can be applied to illumination, projection, automotive headlights, or displays. For instance, when a blue LED serves as the excitation light source, the phosphor-converted LED is designed to leak some of the blue light beyond the fluorescent composite to generate the blue portion of the spectrum, while fluorescent composite convert the remainder of the blue light into one or more visible light-emitting of the spectrum. In one embodiment, the phosphor material in the fluorescent composite material includes green phosphor material and red phosphor material. As such, the phosphor material is excited by the blue light to emit a red light and a green light, which are mixed with the blue light passing through the fluorescent composite material to produce a white light. The color temperature of the white light-emitting device can be adjusted by tuning the type and ratio of the phosphor materials. In one embodiment, the color temperature of the white light-emitting device is 2000K to 6000K.

Below, exemplary embodiments are described in detail with reference to the accompanying drawings so as to be easily realized by a person having ordinary knowledge in the art. The inventive concept may be embodied in various forms without being limited

to the exemplary embodiments set forth herein. Descriptions of well-known parts are omitted for clarity, and like reference numerals refer to like elements throughout.

### EXAMPLES

### Preparation Example 1

Li₂O, Na₂O, K₂O, ZnO, B₂O₃, Al ₂O₃, Bi₂O₃, and SiO₂ were weighed according to the wt % in Table 1 (such as the parts by weight in Table 2), put into a platinum crucible, and heated to 800° C. to 1000° C. to be melted. The melted mixture was water-quenched to form a glass bulk. The glass bulk was initially cracked and then ball-milled to obtain glass powder with D₅₀ of about 10 μm.

Each of the glass powders (Serial No. A to N) was evenly mixed with phosphor material Lu₃Al₅O₁₂:Ce³⁺ and (Ca,Sr)AlSiN₃:Eu²⁺, filled in a mold, and then molded by oil hydraulic compression to form a circular sheet preform with a diameter of 5 cm and a thickness of 1 cm. The preform was sintered at 600° C. to form a fluorescent composite material. In Tables 1 and 2, the compatibility of the glass powder and the phosphor material is represented as ◯ when it was excellent, Δ when it was lower, and x when it was poor. The excellent compatibility means that the luminescent properties of the phosphors were preserved after the formation of the composite material of the phosphor materials and the glass powder. The poor compatibility means that the luminescent properties of the phosphor material were dramatically declined after formation of the composite material. As shown in Tables 1 and 2, the glass powders of Serial No. B, D, and H had excellent compatibility with the phosphor powders.

TABLE 1

| | Composition | | | | | | |
|---|---|---|---|---|---|---|---|
| | A | B | C | D | E | F | G |
| Li₂O | 5 wt % | — | — | — | — | — | — |
| Na₂O | — | — | 5 wt % | 0.5 wt % | 20 wt % | 5 wt % | 5 wt % |
| K₂O | — | 5% | — | — | — | — | — |
| ZnO | 5 wt % | 5% | 5 wt % | 5 wt % | 5 wt % | 1 wt % | 20 wt % |
| B₂O₃ | 20 wt % | 20% | 10 wt % | 24.5 wt % | 10 wt % | 20 wt % | 10 wt % |
| Al₂O₃ | — | — | 10 wt % | — | — | — | — |
| Bi₂O₃ | 60 wt % | 60% | 60 wt % | 60 wt % | 55 wt % | 70 wt % | 55 wt % |
| SiO₂ | 10 wt % | 10% | 10 wt % | 10 wt % | 10 wt % | 4 wt % | 10 wt % |
| Phosphor | Δ | ◯ | Δ | ◯ | Δ | Δ | Δ |
| compatibility | | | | | | | |
| | Composition | | | | | | |
| | H | I | J | K | L | M | N |
| Li₂O | — | — | — | — | — | — | — |
| Na₂O | 10 wt % | 5 wt % | 5 wt % | 20 wt % | 1 wt % | 9 wt % | 3 wt % |
| K₂O | — | — | — | — | — | — | — |
| ZnO | 20 wt % | 1 wt % | 5 wt % | 20 wt % | 1 wt % | 10 wt % | 2 wt % |
| B₂O₃ | 3 wt % | 60 wt % | — | 30 wt % | 3 wt % | 10 wt % | 5 wt % |
| Al₂O₃ | — | — | 20 wt % | — | — | — | — |
| Bi₂O₃ | 60 wt % | 30 wt % | 55 wt % | 25 wt % | 90 wt % | 70 wt % | 60 wt % |
| SiO₂ | 7 wt % | 4 wt % | 5 wt % | 5 wt % | 5 wt % | 1 wt % | 30 wt % |
| Phosphor | ◯ | Δ | Δ | Δ | Δ | Δ | X |
| compatibility | | | | | | | |

TABLE 2
(On the basis of the weight of Bi₂O₃)

| | Composition | | | | | | |
|---|---|---|---|---|---|---|---|
| | A | B | C | D | E | F | G |
| Li₂O | 8.3 | — | — | — | — | — | — |
| Na₂O | — | — | 8.3 | 0.8 | 36.4 | 7.1 | 9.1 |
| K₂O | — | 8.3 | — | — | — | — | — |
| ZnO | 8.3 | 8.3 | 8.3 | 8.3 | 9.1 | 1.4 | 36.4 |
| B₂O₃ | 33.3 | 33.3 | 16.6 | 40.8 | 18.2 | 28.5 | 18.2 |
| Al₂O₃ | — | — | 16.6 | — | — | — | — |
| Bi₂O₃ | 100 | | | | | | |
| SiO₂ | 16.6 | 16.6 | 16.6 | 16.6 | 18.2 | 5.7 | 18.2 |
| Phosphor | Δ | ◯ | Δ | ◯ | Δ | Δ | Δ |
| compatibility | | | | | | | |
| | Composition | | | | | | |
| | H | I | J | K | L | M | N |
| Li₂O | — | — | — | — | — | — | — |
| Na₂O | 16.7 | 16.6 | 9.1 | 80 | 1.1 | 12.6 | 5 |
| K₂O | — | — | — | — | — | — | — |
| ZnO | 33.3 | 3.3 | 9.1 | 80 | 1.1 | 14.3 | 3.3 |
| B₂O₃ | 5 | 200 | — | 120 | 3.3 | 14.3 | 8.3 |
| Al₂O₃ | — | — | 36.4 | — | — | — | — |
| Bi₂O₃ | 100 | | | | | | |
| SiO₂ | 11.7 | 13.3 | 9.1 | 20 | 5.5 | 1.4 | 50 |
| Phosphor | ◯ | Δ | Δ | Δ | Δ | Δ | X |
| compatibility | | | | | | | |

### Comparative Example 1

Na₂O, K₂O, ZnO, B₂O₃, Al₂O₃, SiO₂, BaO, CaO, and MgO were weighed according to the wt % in Table 3, put into a platinum crucible, and heated to 800° C. to 1000° C. to be melted. The melted mixture was water-quenched to form a glass bulk. The glass bulk was initially cracked and then ball-milled to obtain glass powder with D₅₀ of about 10 μm.

Each of the glass powders (Serial No. Oand P) was evenly mixed with phosphor material Lu₃Al₅O₁₂:Ce³⁺ and (Ca,Sr)AlSiN₃:Eu²⁺, filled in a mold, and then molded by oil hydraulic compression to form a circular sheet preform with a diameter of 5 cm and a thickness of 1 cm. The preform was sintered at 600° C. to form a fluorescent composite material. As shown in Table 3, the glass powders of Serial No. O and P lack of Bi₂O₃ and exhibited the poor compatibility with the phosphor powders.

TABLE 3

| Composition | O | P |
|---|---|---|
| Li₂O | — | — |
| Na₂O | 7 wt % | 5 wt % |
| K₂O | 3 wt % | 2 wt % |
| ZnO | — | 10 wt % |
| B₂O₃ | 7 wt % | 5 wt % |
| Al₂O₃ | 8 wt % | 10 wt % |
| Bi₂O₃ | — | — |
| SiO₂ | 70 wt % | 60 wt % |
| BaO | 3 wt % | — |
| CaO | 2 wt % | 5 wt % |
| MgO | — | 3 wt % |
| Phosphor | X | X |
| compatibility | | |

### Example 1

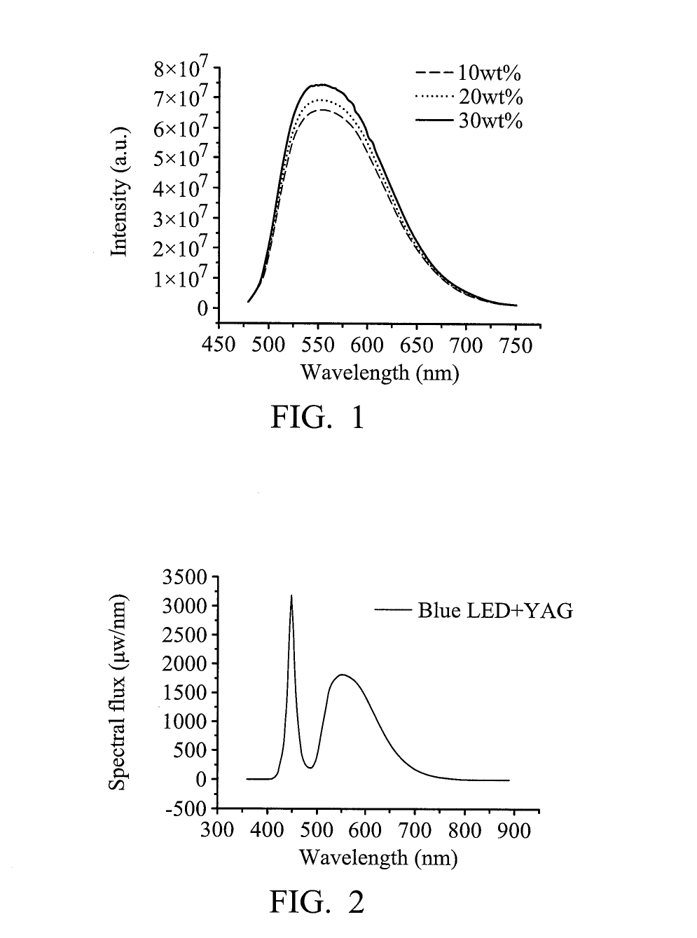

90 wt %, 80 wt %, and 70 wt % of the glass powder of Serial No. B in Preparation Example 1 were mixed with 10 wt %, 20 wt %, and 30 wt % of a yellow phosphor powder Y₃Al₅O₁₂:Ce³⁺ (YAG, YY563LL commercially available from China Glaze Co., Ltd.). The mixture was preformed and sintered to form a fluorescent composite material. The fluorescent composite material was excited by a blue light with a wavelength of 450 nm to generate a broad band emission with an emission peak at 550 nm, as shown in FIG. 1. The emission spectrum was measured by HORIBA Fluoromax-4. The emission intensity was found to rise as the ratio of YAG increases.

The fluorescent composite material sheet was collocated with a blue LED. The electroluminescent spectrum of the package was measured by Labsphere integrating sphere was shown in FIG. 2. Some part of the blue light passed through the fluorescent composite material (see left portion of the electroluminescent spectrum), and some part of the blue light excited YAG to emit a yellow light (see right portion of the electroluminescent spectrum). The electroluminescent spectrum of the package is the result of the blue light and the yellow light.

### Example 2

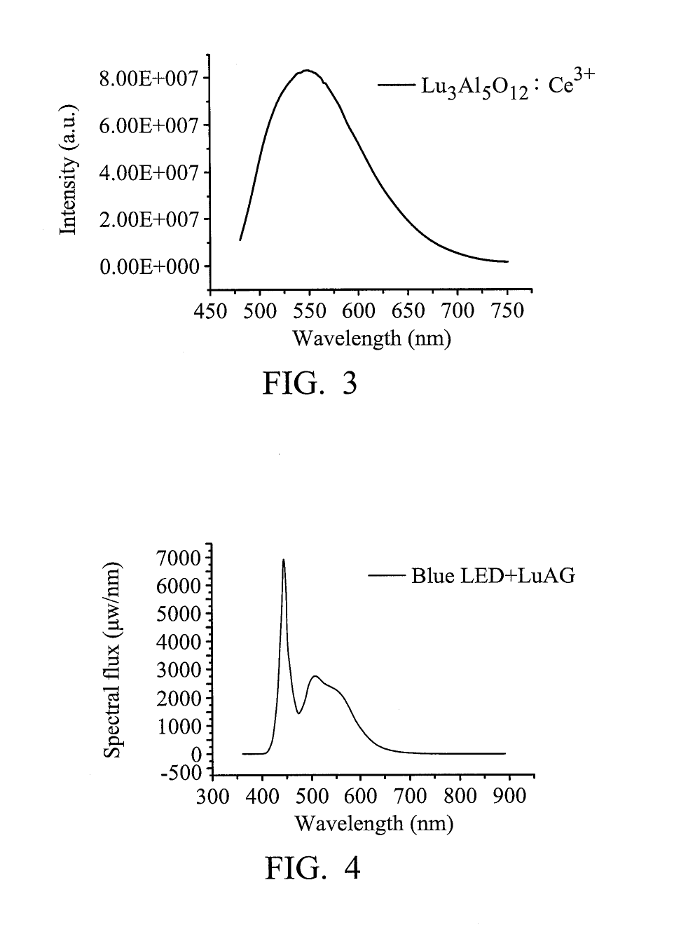

90 wt % of the glass powder of Serial No. B in Preparation Example 1 was mixed with 10 wt % of a green phosphor powder Lu₃Al₅O₁₂:Ce³⁺ (LuAG, LG535L commercially available from China Glaze Co., Ltd.). The mixture was preformed and sintered to form a fluorescent composite material. The fluorescent composite material was excited by a blue light with a wavelength of 450 nm to obtain a broad band emission with an emission peak between 520 nm to 545 nm, as shown in FIG. 3. The emission spectrum was measured by HORIBA Fluoromax-4.

The fluorescent composite material sheet was collocated with a blue LED and packaged. The electroluminescent spectrum of the package was measured by Labsphere integrating sphere, as shown in FIG. 4. Some part of the blue light passed through the fluorescent composite material (see left portion of the electroluminescent spectrum), and some part of the blue light excited LuAG to emit a green light (see right portion of the electroluminescent spectrum). The electroluminescent spectrum of the package is the mixing result of the blue light and the green light.

### Example 3

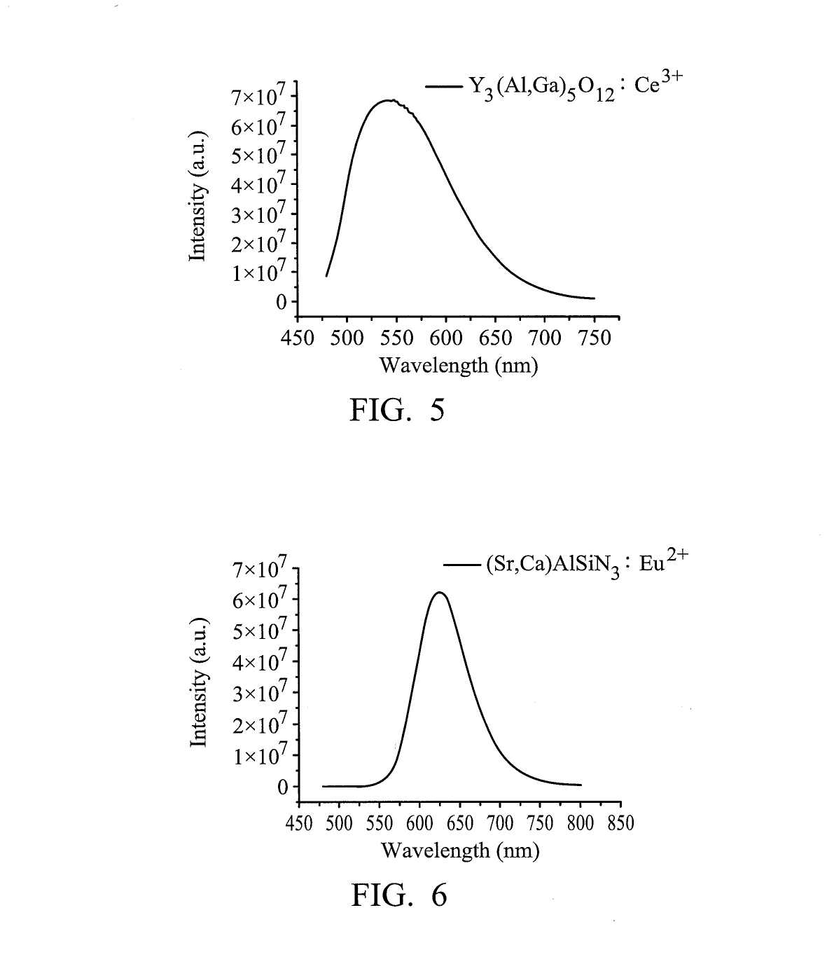

90 wt % of the glass powder of Serial No. B in Preparation Example 1 was mixed with 10 wt % of a green phosphor powder Y₃(Al,Ga)₅O₁₂:Ce³⁺ (GaYAG, GG535M commercially available from China Glaze Co., Ltd.). The mixture was preformed and sintered to form a fluorescent composite material. The fluorescent composite material was excited by a blue light with a wavelength of 450 nm to generate a broad band emission with an emission peak between 520 nm to 545 nm, as shown in FIG. 5. The emission spectrum was measured by HORIBA Fluoromax-4.

### Example 4

90 wt % of the glass powder of Serial No. B in Preparation Example 1 was mixed with 10 wt % of a red phosphor powder (Ca,Sr)AlSiN₃:Eu²⁺ (BR102Q commercially available from Mitsubishi Chemical Cooperation). The mixture was preformed and sintered to form a fluorescent composite material. The fluorescent composite material was excited by a blue light with a wavelength of 450 nm to obtain a broad band emission with an emission peak between 615 nm to 670 nm, as shown in FIG. 6. The emission spectrum was measured by HORIBA Fluoromax-4.

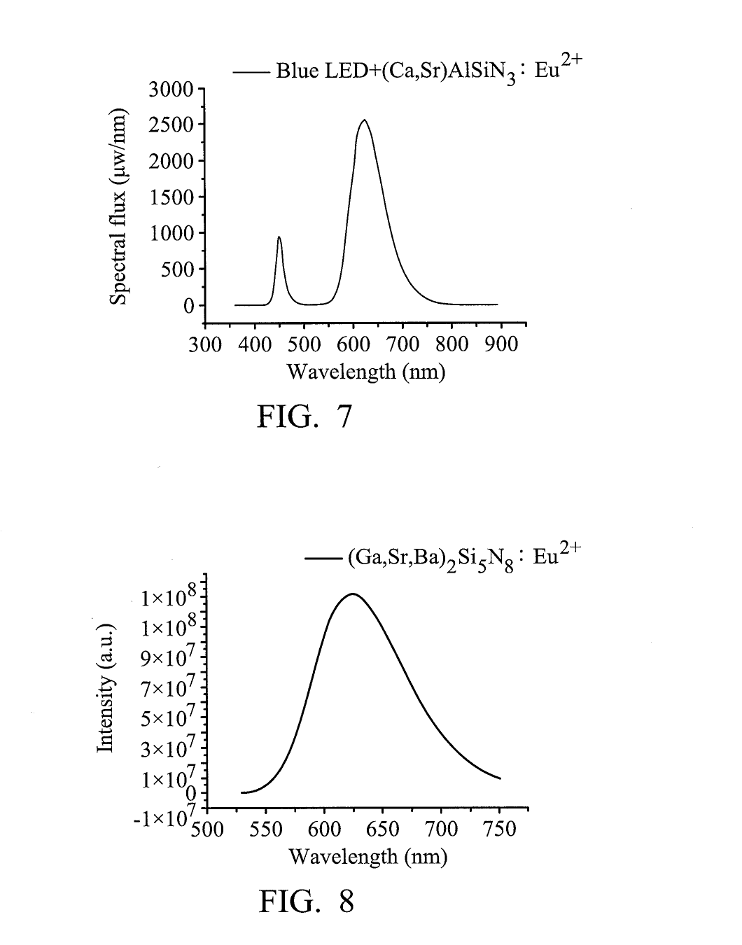

The fluorescent composite material sheet was collocated with a blue LED and packaged. The electroluminescent spectrum of the package was measured by Labsphere integrating sphere, as shown in FIG. 7. Some part of the blue light passed through the fluorescent composite material (see left portion of the electroluminescent spectrum), and some part of the blue light excited (Ca,Sr)AlSiN₃:Eu²⁺ to emit a red light (see right portion of the electroluminescent spectrum). The electroluminescent spectrum of the package is the mixing result of the blue light and the red light.

### Example 5

90 wt % of the glass powder of Serial No. B in Preparation Example 1 was mixed with 10 wt % of a red phosphor powder (Ca,Sr)₂Si₅N₈:Eu²⁺ (NR625A2 commercially available from China Glaze Co., Ltd.). The mixture was preformed and sintered to form a fluorescent composite material. The fluorescent composite material was excited by a blue light with a wavelength of 450 nm to obtain a broad band emission with an emission peak between 615 nm to 670 nm, as shown in FIG. 8. The emission spectrum was measured by HORIBA Fluoromax-4.

### Example 6

85 wt % of the glass powder of Serial No. B in Preparation Example 1 was mixed with 15 wt % of phosphor powders. The mixture was preformed and sintered to form a fluorescent composite material. The phosphor powders included a green phosphor powder Lu₃Al₅O₁₂:Ce³⁺ and a red phosphor powder (Ca,Sr)AlSiN₃:Eu²⁺, in which the green phosphor powder and the red phosphor powder had a weight ratio of 95:5.

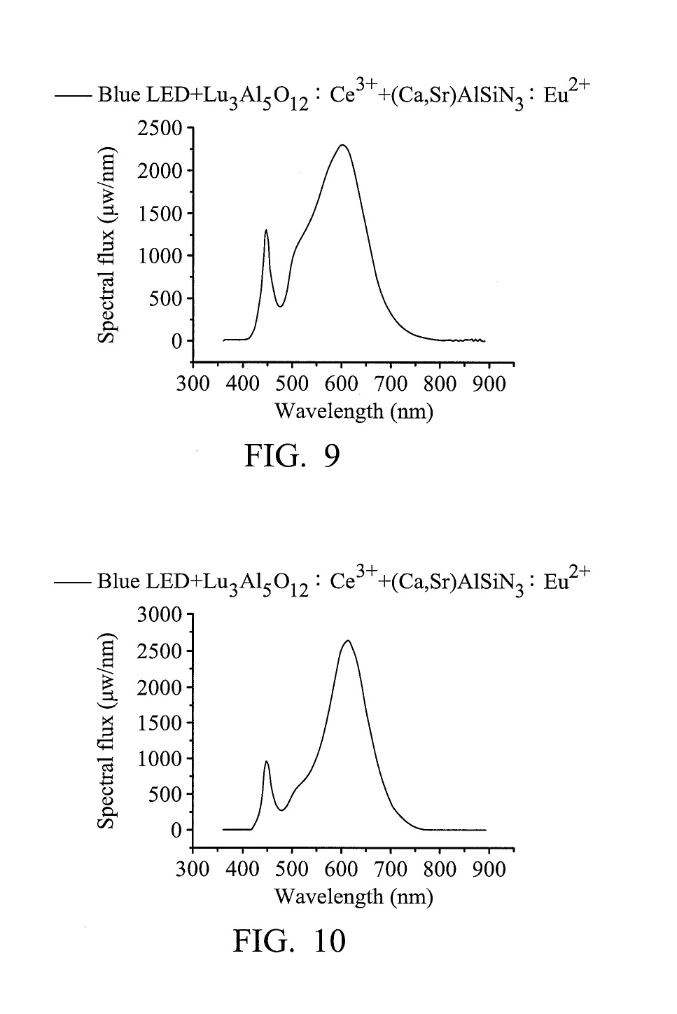

The white LED was fabricated by combining a blue LED and the fluorescent composite material sheet. The electroluminescent spectrum of the package was measured by Labsphere integrating sphere, as shown in FIG. 9. Some part of the blue light passed through the fluorescent composite material (see left portion of the electroluminescent spectrum), and some part of the blue light excited Lu₃Al₅O₁₂:Ce³⁺ and (Ca,Sr)AlSiN₃:Eu²⁺ to emit a green light and a red light (see right portion of the electroluminescent spectrum). The electroluminescent spectrum of the package is the mixing result of the blue light, the green light, and the red light. The color temperature of the white LED was found to be 3000K.

### Example 7

85 wt % of the glass powder of Serial No. B in Preparation Example 1 was mixed with 15 wt % of phosphor powders. The mixture was preformed and sintered to form a fluorescent composite material. The phosphor powders included a green phosphor powder Lu₃Al₅O₁₂:Ce³⁺ and a red phosphor powder (Ca,Sr)AlSiN₃:Eu²⁺, in which the green phosphor powder and the red phosphor powder had a weight ratio of 90:10.

The white LED was fabricated by combining a blue LED and the fluorescent composite material sheet. The electroluminescent spectrum of the package was measured by Labsphere integrating sphere, as shown in FIG. 10. Some part of the blue light passed through the fluorescent composite material (see left portion of the electroluminescent spectrum), and some part of the blue light excited Lu₃Al₅O₁₂:Ce³⁺ and (Ca,Sr)AlSiN₃:Eu²⁺ to emit a green light and a red light (see right portion of the electroluminescent spectrum). The electroluminescent spectrum of the package is the result of the blue light, the green light, and the red light. The color temperature of the white LED was found to be 2000K.

### Example 8

85 wt % of the glass powder of Serial No. B in Preparation Example 1 was mixed with 15 wt % of phosphor powders. The mixture was preformed and sintered to form a fluorescent composite material. The phosphor powders included a green phosphor powder Y₃(Al,Ga)₅O₁₂:Ce³⁺ and a red phosphor powder (Ca,Sr)AlSiN₃:Eu²⁺, in which the green phosphor powder and the red phosphor powder had a weight ratio of 85:15.

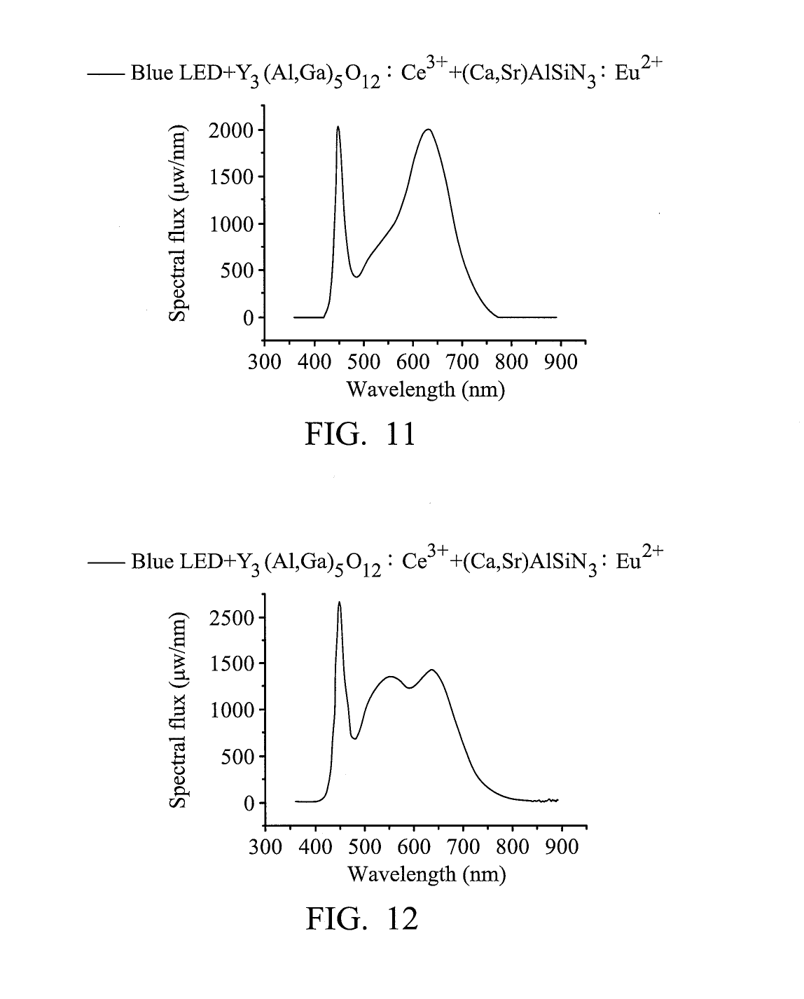

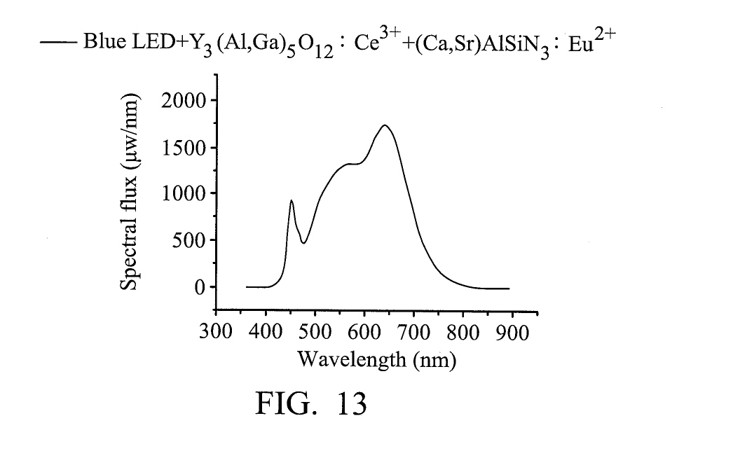

The white LED was composed of a blue LED and the fluorescent composite material sheet. The electroluminescent spectrum of the package was measured by Labsphere integrating sphere, as shown in FIG. 11. Some part of the blue light passed through the fluorescent composite material (see left portion of the electroluminescent spectrum), and some part of the blue light excited Y₃(Al,Ga)₅O₁₂:Ce³⁺ and (Ca,Sr)AlSiN₃:Eu²⁺ to emit a green light and a red light (see right portion of the electroluminescent spectrum). The electroluminescent spectrum of the package is the result of the blue light, the green light, and the red light. The color temperature of the white LED was found to be 2700K.

### Example 9

90 wt % of the glass powder of Serial No. B in Preparation Example 1 was mixed with 10 wt % of phosphor powders. The mixture was preformed and sintered to form a fluorescent composite material. The phosphor powders included a green phosphor powder Y₃(Al,Ga)₅O₁₂:Ce³⁺ and a red phosphor powder (Ca,Sr)AlSiN₃:Eu²⁺, in which the green phosphor powder and the red phosphor powder had a weight ratio of 90:10.

The white LED was fabricated by combining a blue LED and the fluorescent composite material sheet. The electroluminescent spectrum of the package was measured by Labsphere integrating sphere, as shown in FIG. 12. Some part of the blue light passed through the fluorescent composite material (see left portion of the electroluminescent spectrum), and some part of the blue light excited Y₃(Al,Ga)₅O₁₂:Ce³⁺ and (Ca,Sr)AlSiN₃:Eu²⁺ to emit a green light and a red light (see right portion of the electroluminescent spectrum). The electroluminescent spectrum of the package is the result of the blue light, the green light, and the red light. The color temperature of the white LED was determined to be 5000K.

### Example 10

80 wt % of the glass powder of Serial No. B in Preparation Example 1 was mixed with 20 wt % of phosphor powders. The mixture was preformed and sintered to form a fluorescent composite material. The phosphor powders included a green phosphor powder Y₃(Al,Ga)₅O₁₂:Ce³⁺ and a red phosphor powder (Ca,Sr)AlSiN₃:Eu²⁺, in which the green phosphor powder and the red phosphor powder had a weight ratio of 90:10.

The white LED was composed of a blue LED and the fluorescent composite material sheet. The electroluminescent spectrum of the package was measured by Labsphere integrating sphere, as shown in FIG. 12. The blue LED emits a blue light, some part of the blue light passed through the fluorescent composite material (see left portion of the electroluminescent spectrum), and some part of the blue light excited Y₃(Al,Ga)₅O₁₂:Ce³⁺ and (Ca,Sr)AlSiN₃:Eu²⁺ to emit a green light and a red light (see right portion of the electroluminescent spectrum). The electroluminescent spectrum of the package is the result of the blue light, the green light, and the red light. The color temperature of the white LED was determined to be 3000K.

It will be apparent to those skilled in the art that various modifications and variations can be made to the disclosed methods and materials. It is intended that the specification and examples be considered as exemplary only, with a true scope of the disclosure being indicated by the following claims and their equivalents.

What is claimed is:

1. A glass material, having a composition of:
M₂O—ZnO-M′₂O₃—Bi₂O₃—SiO₂, wherein
M is Li, Na, K, or a combination thereof; and
M′ is B, Al, or a combination thereof,
wherein the glass material has
0.5 wt % to 20 wt % of M₂O;
1 wt % to 20 wt % of ZnO;
3 wt % to 60 wt % of M′₂O₃;
25 wt % to 90 wt % of Bi₂O₃; and
1 wt % to 30 wt % of SiO₂.

2. The glass material as claimed in claim 1, having
5 wt % to 10 wt % of M₂O;
5 wt % to 20 wt % of ZnO;
3 wt % to 24.5 wt % of M′₂0₃;
60 wt % of Bi₂O₃; and
7 wt % to 10 wt % of SiO₂.

3. The glass material as claimed in claim 1, wherein
Bi₂O₃ and M₂O have a weight ratio of 100:0.8 to 100:80;
Bi₂O₃ and ZnO have a weight ratio of 100:1 to 100:80;
Bi₂O₃ and M′₂O₃ have a weight ratio of 100:3 to 100:200; and
Bi₂O₃ and SiO₂ have a weight ratio of 100:1 to 100:50.

4. The glass material as claimed in claim 1, wherein
Bi₂O₃ and M₂O have a weight ratio of 100:0.8 to 100:16.7;
Bi₂O₃ and ZnO have a weight ratio of 100:8 to 100:34;
Bi₂O₃ and M′₂O₃ have a weight ratio of 100:5 to 100:40.8; and
Bi₂O₃ and SiO₂ have a weight ratio of 100:11 to 100:16.6.

5. A fluorescent composite material, comprising:
a phosphor material; and
the glass material as claimed in claim 1.

6. The fluorescent composite material as claimed in claim 5, wherein the fluorescent material is red phosphor material, a green phosphor material, a yellow phosphor material, or a combination thereof.

7. The fluorescent composite material as claimed in claim 5, wherein the phosphor material comprises silicate, nitride, oxynitride, sulfide, or aluminate.

8. The fluorescent composite material as claimed in claim 5, wherein the phosphor material and the glass material have a weight ratio of 1:999 to 90:10.

9. A light-emitting device, comprising:
an excitation light source; and
the fluorescent composite material as claimed in claim 5 on the excitation light source.

10. The light-emitting device as claimed in claim 9, wherein the excitation light source includes light-emitting diode, laser diode, organic light-emitting diode, cold cathode fluorescent lamp, or external-electrode fluorescent lamp.

11. The light-emitting device as claimed in claim 9, being applied to illumination, projection, automotive headlights, or displays.
